(19) United States
(12) Patent Application Publication
(10) Pub. No.: US 2008/0132408 A1
(43) Pub. Date: Jun. 5, 2008

(54) CARBON BLACK MONOLITH, CARBON BLACK MONOLITH CATALYST, METHODS FOR MAKING SAME, AND USES THEREOF

(75) Inventors: Robert L. Mitchell, Atlanta, GA (US); Lee M. Mitchell, Atlanta, GA (US); Joseph H. Keller, Abingdon, VA (US); Jack H. L'Amoreaux, Snellville, GA (US); Miron Abramovici, Cliffside Park, NJ (US); Kon Jiun Lee, Norcross, GA (US)

Correspondence Address: SUTHERLAND ASBILL & BRENNAN LLP, 999 PEACHTREE STREET, N.E., ATLANTA, GA, 30309, US

(73) Assignee: APPLIED TECHNOLOGY LIMITED PARTNERSHIP, Doraville, GA (US)

(21) Appl. No.: 11/870,861

(22) Filed: Oct. 11, 2007

Related U.S. Application Data
(60) Provisional application No. 60/828,988, filed on Oct. 11, 2006.

(51) Int. Cl. B01J 23/50; D01D 5/24; B29C 47/76; B32B 3/12; B01J 23/52; F26B 5/06; B05D 3/02; B01J 21/18; B01J 23/00; B01J 23/02

(52) U.S. Cl. 502/183; 264/209.6; 264/101; 34/287; 428/116; 502/180; 502/182; 502/185; 502/184; 427/383.3

(57) ABSTRACT

A carbon black monolith comprising a matrix comprising ceramic material and carbon black dispersed throughout the matrix and a method for making a carbon black monolith comprising extruding an extrudable mixture including a carbon black, a ceramic forming material, water, an extrusion aid, and a flux material. A carbon black monolith catalyst comprising a finished self-supporting carbon black monolith having at least one passage therethrough, and comprising a supporting matrix and carbon black dispersed throughout the supporting matrix and at least one catalyst precursor on the finished self-supporting carbon black monolith. A method for making and a method for use of such a carbon black monolith catalyst in catalytic chemical reactions are also disclosed.

### RELATED APPLICATION DATA

The present application claims priority under 35 U.S.C. § 119 to U.S. Provisional Application No. 60/828,988, entitled “Carbon Black Monolith, Carbon Black Monolith Catalyst, Methods for Making Same and Uses Thereof”, filed on Oct. 11, 2006, the disclosure of which is incorporated herein by reference in its entirety.

### FIELD OF THE INVENTION

This invention relates to monoliths including carbon and more particularly to monoliths including ceramic material and carbon black and using said monolith as a catalyst in fluid reaction streams.

### BACKGROUND OF THE INVENTIONS

Carbon catalysts are useful catalysts in many applications. To catalyze a chemical reaction in a fluid stream with carbon, the fluid stream is directed adjacent the carbon. The carbon can be in the form of particles in a packed column, a coating on a substrate, a monolith with passages for fluid flow therethrough, and the like. Carbon monoliths having open passages therethrough, such as a honeycomb-shaped activated carbon monolith, are desirable for applications wherein a reasonably high rate of fluid flow and a low level of back pressure are required, but formation of such shapes with a level of strength sufficient to withstand handling and use as a catalyst is problematic. Activated carbon monoliths can be made with sufficient strength for many applications. Other sources of carbon, however, are desirable for some carbon monolith applications and formation of monoliths from alternative sources of carbon with sufficient strength is still problematic.

Carbon-supported catalysts play a particularly important role in a large variety of industrial chemical processes, pharmaceutical industry synthesis, environmental protection applications, and the like. Carbon-supported catalysts enable chemical reactions to occur much faster, or at lower temperatures, because of changes that they induce in the reactants. Carbon-supported catalysts may lower the energy of the transition state of chemical reactions, thus lowering the activation energy. Therefore, molecules that would not have had the energy to react, or that have such low energies that it is likely that they would take a long time to do so, are able to react in the presence of a carbon-supported catalyst by reducing the energy required for the reaction to occur. Not only do carbon-supported catalysts increase the rate of reaction, but they may also drive a reaction towards the desired product.

Typically, catalysts are applied to a substrate before introduction to a chemical process. Desirably, the substrate holds the catalyst while presenting the catalyst to reactants in the chemical process. Conventional catalyst substrates, or supports, include carbon powder, carbon granules, or ceramic granules arranged in a bed, and ceramic monoliths.

Traditionally, carbons utilized as catalyst supports are either granules or powders. In a perfect world, carbons used for catalyst supports would be chosen only for their activity and selectivity. The more common features that are important factors in determining activity and selectivity are surface area, pore volume, pore size, ash content, friability, availability, and/or other elements contained in the carbon matrix. The foregoing are not the only desirable features; rather, they are ones that are known to be obtainable within the art.

Conventionally, carbon catalyst supports are chosen more for properties that meet parameters of the chemical process, than for features that would make purely the best catalyst, for highest activity and selectivity. While a particular carbon substrate might have the best features for activity and selectivity, it may not be the best choice considering the chemical process parameters. For example, carbon granules suffer from attrition making exact pressure drop determinations difficult, and they scale up poorly in chemical processes. When chemical reactants trickle through a bed of granular carbon catalyst, the catalyst must be as attrition resistant as possible, less the bed collapse and flow cease or the catalyst metals be lost. Attrition is a particularly aggravating issue, because it alters the physical parameters of the chemical process as it proceeds, and causes financial loss, particularly when the catalyst is a precious metal. For this reason, carbons of choice are typically nutshell carbons, which are durable, but which have very small pores that can harshly limit activity and selectivity. When a powder carbon catalyst is stirred violently in a batch reactor with chemical reactants, the carbon catalyst must be non-friable to some degree to allow it to be economically separated from the reaction at termination in order to prevent loss of the catalyst. Thus, perhaps one must exclude carbons with better catalytic properties, but which are too friable.

Ceramic catalytic monoliths have been used in the art for advantages they provide over fixed bed supports, such as predictable pressure drop through the catalyst bed, scalability based on a model that predicts performance through incremental increases in volume of catalyst with respect to the same reactant volume flow, separation of the catalysts from the reaction and from the product stream, practical continuous operation and ease of replacement of the catalyst, and layering of the catalyst or the catalysts either on the monoliths' wall depth or wall length, or both. The low pressure drop of catalytic monoliths' allows them to operate at higher gas and liquid velocities. These higher velocities of gas and liquids promote high mass transfer and mixing.

Catalytic monolith development has been an ongoing process in an effort to enhance catalytic activity, catalytic selectivity, and catalyst life. Although monoliths have advantages over fixed bed supports, there are still problems associated with traditional ceramic monoliths. Exposure of the catalytic metal in the catalytic monolith to the reactants is necessary to achieve good reaction rates, but efforts to enhance exposure of the catalytic metal often have been at odds with efforts to enhance adhesion of the metal to the monolith substrate. Thus, catalytic ceramic monoliths have fallen short of providing optimal catalytic selectivity and activity.

As seen below, ceramic carbon catalyst monoliths developed to date, on one hand may provide good selectivity and activity, but on the other hand may not be suitable for process parameters such as durability and inertness. Conversely, ceramic carbon catalyst monoliths suitable for such process parameters may have diminished selectivity and activity. Thus, it would be ideal to take a carbon with the best features for a catalyst based on its activity and selectivity, and then form a carbon monolith catalyst to fit the process parameters of choice.

There have been efforts to form a carbon support that would have some of the features of a ceramic monolith catalyst. These efforts fall into three general classes: gluing or binding of carbon granules or powder to form larger structures, coating ceramic monoliths with an organic compound such as sugars or liquid polymer plastics, followed by carbonization of the organic compound on the ceramic monolith, and formation of a structure from an organic material, such as a plastic or nylon, followed by carbonization of the structure.

The binding of carbons gives some degree of choice of carbon precursor, but the result is a carbon support with the binder as a new element. These binders can vary from organic glues to pitches. In most cases, the binders are susceptible to attack by the reaction media in application. Some cause side reactions, or poison the catalyst. Furthermore, the result is a random binding of granules, or the creation of a new granule—a chopped extrudate of powdered carbon and binder. In either case, the parameters of flow are not predictable by simple, understandable models. Although the carbons selected have generally been in use as unbound catalyst supports, and unbound activity and selectivity information on the carbon can sometimes be used, still the binder is not inert, and therefore binder influence is always an issue.

Carbonization of an organic material forms a support with little hope of prior carbon activity or selectivity information. Because the carbon is formed each time the support is prepared, and is limited to those precursor and organic materials that can be coated or formed and carbonized, commercially available carbons, known in the art to produce excellent catalyst, are excluded from consideration. Furthermore, the carbons normally used in preparation of catalyst supports are prepared from naturally occurring materials such as wood, peat, nutshell, and coal, although alternative sources of carbon for use as catalyst supports are still desirable. Carbon produced from naturally occurring material is known to retain some of the beneficial structural characteristics as well as chemical nature of the precursor material. These characteristics are known to be important to the final activity and selectivity of the catalyst. While carbonization of a preformed organic monolith may be a way of producing a carbon coating or structure, it extends marginally the catalyst art, and does not produce a catalyst utilizing the known carbon methods of choice in the art.

Activated carbon monolith catalysts have been developed and are described in U.S. patent application Ser. No. 11/102,452 filed on Apr. 8, 2005, the disclosure of which is expressly incorporated herein by reference in its entirety. While such activated carbon monolith catalysts have attrition resistance, predictable pressure drop, high selectivity, high activity, and scalability for commercial economy and efficiency, there is a need for carbon monolith catalysts made with carbon from an alternative source and still having the same or similar attributes.

### SUMMARY OF THE INVENTION

Objects and advantages of the invention will be set forth in part in the following description, or may be obvious from the description, or may be learned through practice of the invention. Unless otherwise defined, all technical and scientific terms and abbreviations used herein have the same meaning as commonly understood by one of ordinary skill in the art to which this invention pertains. Although methods and compositions similar or equivalent to those described herein can be used in the practice of the present invention, suitable methods and compositions are described without intending that any such methods and compositions limit the invention herein.

This invention addresses the above-described needs by providing a method of forming a carbon black monolith comprising extruding an extrudable mixture including a carbon black, a ceramic forming material, an extrusion aid, water, and a flux material. The flux material enhances the fusing of the ceramic forming material upon firing by lowering the temperature at which the ceramic forming material fuses and forms ceramic bonds. This allows the monolith to be fired at a lower temperature and for a shorter time. In addition, the invention encompasses methods of drying the wet extruded monolith including vacuum drying, freeze drying, super critical drying, and humidity control drying. Such drying methods allow the wet extruded monolith to be dried without cracking of the monolith.

More particularly, this invention encompasses a method of forming a monolith comprising the steps of (a) extruding an extrudable mixture through an extrusion die such that a monolith is formed having a shape wherein the monolith has at least one passage therethrough and the extrudable mixture comprises carbon black, a ceramic forming material, a flux material, an extrusion aid, and water, (b) drying the extruded monolith, and (c) firing the dried monolith at a temperature and for a time period sufficient to react the ceramic forming material together and form a ceramic matrix. The extrudable mixture is capable of maintaining the shape of the monolith after extrusion and during drying of the monolith.

This invention encompasses a carbon black monolith made according to the foregoing. The monolith of this invention comprises ceramic material and carbon black dispersed throughout the matrix. The ceramic material is reacted together such that a ceramic matrix is formed and the carbon black is supported by the matrix. The monolith desirably has a plurality of passages therethrough to receive a flow of fluid and is in the shape of a honeycomb. In addition, the monolith desirably has an open frontal area greater than 50% and up to 85% and an axial crushing strength from about 500 to about 1600 psi.

According to another embodiment, the present invention addresses the above-described needs by providing a carbon black monolith catalyst comprising a finished self-supporting carbon black monolith having at least one passage therethrough, and comprising a supporting matrix and carbon black dispersed throughout the supporting matrix, and at least one catalyst precursor supported on the finished self-supporting carbon black monolith. The supporting matrix holds the carbon black in a monolithic form. In preferred embodiments, the supporting matrix comprises a ceramic or another substantially inert material such as carbon. In still other preferred embodiments, the carbon black monolith catalyst can include additionally one or more other types of particulate carbon such as activated carbon.

The carbon black monolith catalyst of this invention is not limited to use of carbon precursor materials that must be carbonized to form a carbon catalyst support. It can include any carbon black from any source. Thus, the carbon black monolith catalyst of this invention can be made with carbon black chosen for its superior activity and selectivity for a given application. The carbon black monolith catalyst can then be expected to have a predictable activity and selectivity based on the knowledge available regarding the particular carbon black used. In addition, the carbon black in the carbon black monolith catalyst of this invention is dispersed throughout the structure of the catalyst, giving depth to the catalyst activity and selectivity. The carbon black is bound by a supporting matrix, which desirably is an inert binder and is not susceptible to attack by reaction media. Furthermore, the carbon black monolith catalyst of this invention exhibits the desirable features of a ceramic monolith, while also presenting the advantage of a choice of a wide variety of particulate carbon substrates. Such desirable features include ease of separation of the catalyst from a product in a chemical reaction, and predictable fluid flow, among others. Because the carbon black is fixed in a monolithic form, regions of the monolith, in particular embodiments, can include different catalysts as desired. Such regions would not migrate in monolithic form as they would with loose carbon black particles.

Accordingly, with the carbon black monolith catalyst of this invention, the catalyst can be chosen based on its superior activity and selectivity, while pressure drop through the monolith is predictable, processes using the carbon black monolith catalyst are scalable based on a model that predicts performance through incremental increases in volume of catalyst with respect to the same volume flow, and the catalyst is separable from the reaction and product streams. The carbon black monolith catalyst is useful in continuous operations which were formerly practical only in batch processes; the carbon black monolith catalyst is easy to replace, and the catalyst precursor can be layered either on the carbon monolith catalyst wall depth or wall length, or both. The carbon black monolith catalyst of this invention can be used in continuous processes because a process stream can flow through it. Due to the low pressure drop through the carbon black monolith catalyst of this invention, continuous processes can operate at high velocities.

In another embodiment of the present invention, a method for making a carbon black monolith catalyst is provided comprising providing a finished self-supporting carbon black monolith having at least one passage therethrough and comprising a supporting matrix and carbon black dispersed throughout the supporting matrix and applying at least one catalyst precursor to said finished extruded carbon black monolith.

In another embodiment of the present invention, a method for catalytic chemical reaction is provided comprising contacting at least one reactant with a carbon black monolith catalyst comprising (a) a finished self-supporting extruded carbon black monolith having at least one passage therethrough and comprising a supporting matrix and carbon black dispersed throughout the supporting matrix, and (b) at least one catalyst precursor on said finished extruded carbon black monolith.

Other objects, features, and advantages of this invention will become apparent from the following detailed description of embodiments, drawings, and claims.

### BRIEF DESCRIPTION OF THE FIGURES

FIG. 1 is a perspective view of a carbon black monolith catalyst made in accordance with an embodiment of the invention.

FIG. 2 is a partial side elevation of a carbon black monolith catalyst of FIG. 1 with a portion of the skin removed to illustrate the flow of fluid through the honeycomb passages of the monolith.

In describing the proffered embodiment of the invention, which is illustrated in the drawings, specific terminology will be resorted to for the sake of clarity. However, it is not intended that the invention be limited to the specific terms so selected, and it is to be understood that each specific term includes all technical equivalents which operate in a similar manner to accomplish a similar purpose.

### DETAILED DESCRIPTION OF EMBODIMENTS

Reference now will be made in detail to the presently proffered embodiments of the invention, one or more examples of which are illustrated in the accompanying drawings. Each example is provided by way of explanation of embodiments of the invention, not limitation of the invention. In fact, it will be apparent to those skilled in the art that various modifications and variations can be made in the present invention without departing from the spirit or scope of the invention. For instance, features illustrated or described as part of one embodiment, can be used on another embodiment to yield a still further embodiment. Thus, it is intended that the present invention cover such modifications and variations within the scope of the appended claims and their equivalents.

As summarized above, this invention encompasses a method of forming a carbon black monolith comprising extruding an extrudable mixture including a carbon black, a ceramic forming material, an extrusion aid, water, and a flux material, a carbon black monolith made according to the foregoing process. Furthermore, this invention encompasses a carbon black monolith catalyst comprising a finished self-supporting carbon black monolith having at least one passage therethrough, and comprising a supporting matrix and carbon black dispersed throughout the supporting matrix, and at least one catalyst precursor on the finished self-supporting carbon black monolith. A method for making an carbon black monolith catalyst, and application of the carbon black monolith catalyst in chemical processes, are also disclosed. Embodiments of this invention are described below, including the structure and components of the carbon black monolith and methods for making it and using it, the structure and components of the carbon black monolith catalyst and the methods of making and using the carbon black monolith catalyst.

### Carbon Black Monolith Structure

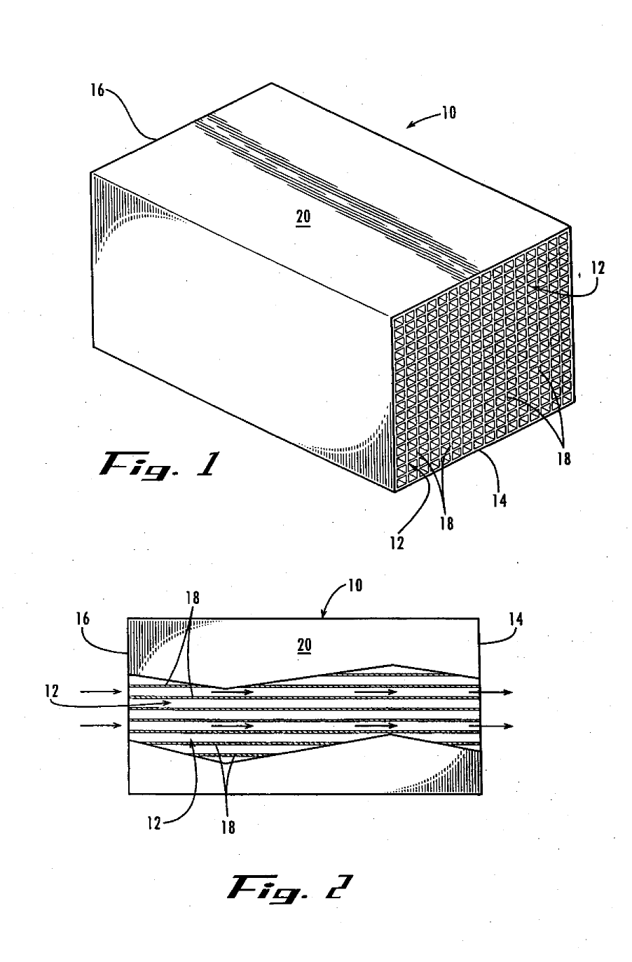

FIG. 1 illustrates a carbon black monolith 10 made according to an embodiment of the present invention. The carbon black monolith 10 comprises a carbon black monolith having a honeycomb shape and comprising carbon black particles, ceramic forming material, and a flux material. The carbon black monolith has a plurality of passages 12 extending through the monolith from a frontal end 14 to a rearward end 16. The passages 12 are substantially square in cross section, linear along their length, and formed by surrounding walls 18, however, the passages can have other cross-sectional shapes such as rectangular, round, triangular, hexagonal, oval, elliptical, and the like. The passages 12 are encased by an outer skin 20 of the monolith.

The carbon black in the carbon black monolith catalyst 10 is dispersed throughout the supporting matrix, giving depth to the catalyst activity and selectivity, if desired. The carbon black is bound by the supporting matrix, which desirably is an inert binder and is not susceptible to attack by reaction media. In the embodiment shown in FIG. 1, the supporting catalyst is a ceramic, but other materials can be used as the supporting matrix. For example, a mixture of carbon black and a polymer resin, such as a thermoplastic polymer, can be formed into a monolith and pyrolyzed to convert the resin into a carbon matrix. Furthermore, the monolith 10 can also comprise other types of carbon particles, such as activated carbon particles, in addition to the carbon black. In a particular embodiment, low aspect ratio carbon fibers can be added to add strength to the monolith.

According to a preferred embodiment, the carbon black monolith is formed by mixing together carbon black, ceramic forming material, flux material, an extrusion aid, and water to make an extrudable mixture, wherein binder is optionally added. The extrudable mixture is extruded through an extrusion die to form the monolith having a honeycomb structure. It is appreciated that the finished extruded carbon black monolith may be a honeycombed structure, or any other structure which is capable of being made by the extrusion process or other ceramic forming processes such as pressing, casting, or injection molding. After extrusion, the extruded honeycomb monolith retains its shape while it is dried and then fired at a temperature and for a time period sufficient to react or fuse the ceramic forming material together and form a ceramic matrix, having carbon black particles dispersed throughout the ceramic matrix or structure, and exhibiting sufficient strength for its intended end use.

Alternatively to extruding an extrudable mixture to form a finished self-supporting carbon black monolith, such monoliths can be formed by pressing a suitable carbon black and binder mixture with a die or press, or by drawing a suitable mixture through a die with a suitable drawing force. For example, a mixture of carbon black (or carbon black and activated carbon or activated carbon alone) and a polymer resin, such as a thermoplastic polymer, can be pressed or drawn to form a monolith and pyrolyzed to convert the resin into a carbon matrix.

In another embodiment, the method for making the carbon black monolith 10 includes first mixing the dry ingredients of the extrudable mixture and then adding the liquid ingredients to the dry mixture; however, the order in which the ingredients are added to the extrudable mixture can be varied by alternating mixing of dry and liquid ingredients as long as the proper amount of moisture is added to make an extrudable mixture which holds its shape during and after extrusion.

Generally, the carbon black can be present in the extrudable mixture in an amount that varies depending on the intended application an the nature of the carbon black. The carbon black is desirably present in the extrudable mixture in an amount from about 10 to about 70 parts, by weight, more desirably, in an amount from about 20 to about 65 parts, by weight, and even more desirably, in an amount from about 20 to about 50 parts, by weight. It should be understood, however, that the carbon black content of the mixture for forming the monolith can be much higher, such as 10 to about 95 parts by weight of the mixture when the monolith is formed by alternative methods such as pressing with a die or press or by drawing a suitable mixture as described hereinabove.

A variety of carbon blacks can be used in this invention. The most suitable carbon black will depend on the intended application, particularly the nature of the chemical process in which the monolith will be used. Thus, the amount of carbon black and the physical properties of the carbon black, such as the particle size, aggregate size, particle and aggregate size distributions, the surface area (total and external), the porosity, morphology, surface activity, and residue content (ash) may be varied depending on the intended application.

Carbon black exists in the form of aggregates of primary particles. It does not generally exist in the form of separate primary particles. In accordance with particular embodiments, desirable carbon blacks have a relatively high structure with larger size aggregates and a lower surface area for ease in dispersion of the carbon black into an extrudable mixture. Likewise, in accordance with particular embodiments, desirable carbon blacks have a aggregate size distribution, residue content and pH suitable for ease of dispersion of the carbon black into an extrudable mixture. In accordance with particular embodiments, desirable carbon blacks have a nitrogen B.E.T. (total) surface from about 25 to about 1500 m²/g. More desirably, the carbon black has a nitrogen B.E.T. surface from about 50 to about 500 m²/g, and even more desirably has a nitrogen B.E.T. surface from about 50 to about 150 m²/g. In accordance with particular embodiments, desirable carbon blacks have a primary particle size of about 10 to about 75 nm, and more desirably have a primary particle size of about 25 to about 50 nm. In accordance with particular embodiments, desirable carbon blacks have a pH from about 6 to about 12, and more desirably from about 8 to about 11. Furthermore, in accordance with particular embodiments, desirable carbon blacks are fluffy and not pelletized, although pelletized carbon blacks can be used.

In accordance with embodiments of this invention, desirable carbon blacks generally include all types of carbon black such as furnace black, channel black, lamp black, thermal black, and the like. In accordance with particular embodiments, suitable carbon blacks include, but are not limited to: Monarch 700, Monarch 280, Vulcan XC-72, Regal 330, and Vulcan XC-605, all available from Cabot Corporation of Billerica, Mass.; and Soltex Acetylene Black 75%-03 JXC1 75 and Soltex Acetylene Black 50%-01 SNA 50, both available from Soltex of Houston, Tex.

The ceramic forming material is present in the extrudable mixture in an amount from about 20 to about 80 parts, by weight, more desirably, in an amount from about 30 to about 65 parts, by weight, and even more desirably, in an amount from about 30 to about 50 parts, by weight. The term ceramic forming material means alumina/silicate-based material which, upon firing, is capable of reacting together with other ingredients to form a high strength, crystal/glass mixed-phase ceramic matrix. In this application, the reacted ceramic material provides a matrix for supporting the carbon black, and has sufficient strength to withstand handling and use of the monolith in the intended application and maintain its intended shape without cracking or otherwise disintegrating. The ceramic forming material desirably includes a substantial portion of moldable material which is plastic in nature and thus, when mixed with liquid, can be molded or extruded into a shape and will maintain that shape through drying and firing. Such a suitable plastic or moldable material is ball clay. A particularly suitable commercially available ball clay is OLD MINE #4 ball clay available from Kentucky-Tennessee Clay Company of Mayfield, Ky. Other suitable plastic-like ceramic forming materials include, but are not limited to, plastic kaolins, smectite clay minerals, bentonite, and combinations thereof. Bentonite and smectites are frequently used in combination with ball clay or kaolin.

The ceramic forming material also desirably includes a filler material which is non-plastic and reduces shrinkage of the monolith during the steps of drying and firing. A non-limiting example of a suitable ceramic filler is calcined kaolin clay. A particularly suitable commercially available calcined kaolin clay is Glomax LL available from Georgia Kaolin Company, Inc. of Union, N.J. The filler desirably is present in the extrudable mixture in an amount up to about 15 parts, by weight, and more desirably, from about 1 to about 15 pans, by weight, and even more desirably, from about 3 to about 10 parts, by weight. Other suitable filler materials include, but are not limited to, calcined kyanite, mullite, cordierite, clay grog, silica, alumina, and other calcined or non-plastic refractory ceramic materials and combinations thereof.

The flux material is present in the extrudable mixture in an amount from about 2 to about 20 parts, by weight, and aids in forming the ceramic bond between the ceramic forming materials by causing the ceramic forming material particles to react together and form a ceramic matrix at a lower firing temperature than if the flux material were not present. More desirably, the flux material is present in the extrudable mixture in an amount from about 4 to about 10 parts, by weight. Suitable flux materials include, but are not limited to, feldspathic materials, particularly nepheline syenite and feldspar, spodumene, soda, potash, sodium silicate, glass frits, other ceramic fluxes, and combinations thereof. A particularly desirable commercially available flux material is MINEX®7 nepheline syenite available from Unimin Specialty Materials, Inc. of Elco, Ill.

The extrudable mixture also includes at least one extrusion aid for increasing the extrudability of the extrudable mixture or the strength of the extruded mixture so that it holds its shape through drying and firing. In particular embodiments of the invention, suitable extrusion aids include surfactants, plasticizers, and binders.

The surfactant is present in the extrudable mixture in an amount sufficient to wet the carbon black and form an extrudable mixture with the carbon black. The particular amount of surfactant used will vary and will be discernible to those of ordinary skill in the art. According to particular embodiments of this invention, suitable available surfactants include, but are not limited to polyethylene glycol esters such as Pegasperse available from Lonza of Switzerland, lignosulfate derivatives such as Tamol available from Rohm & Haas, octophenols such as Triton available from Dow Union Carbide, and nonylphenols such as Tergitol available from Dow Union Carbide.

The binder is present in the extrudable mixture in an amount from about 0.5 to about 30 parts, by weight, based on the solids content of the binder, and enhances the strength of the monolith after extrusion so that the extruded monolith maintains its shape and integrity after extrusion and through drying and firing. The binder is desirably present in the extrudable mixture in an amount from about 0.5 to about 10 parts, by weight, based on the solids content of the binder, and more desirably is present in the extrudable mixture in an amount from about 2 to about 7 parts by weight, based on the solids content of the binder. A particularly suitable binder is methylcellulose, and a suitable commercially available methylcellulose is METHOCEL A4M methylcellulose available from Dow Chemical Company of Midland, Mich. Desirably, methylcellulose is present in the extrudable mixture in an amount from about 0.5 to about 10 parts, by weight, of the extrudable mixture, and more desirably, from about 2 to about 7 parts, by weight. Another suitable binder, used in combination with methylcellulose, is an acrylic binder. Examples of such polymers are JONREZ D-2106 and JONREZ D-2104 available from MeadWestvaco Corporation of New York, N.Y., and Duramax acrylic binder which is available from Rohm & Haas of Montgomeryville, Pa. The acrylic polymer, having a medium to high glass transition temperature, is desirably present in an amount from zero up to about 4 parts, by weight, of the extrudable mixture, based on the solids content of the acrylic binder. Other suitable binders include hydroxypropyl methylcellulose polymers, CMC, polyvinyl alcohol, and other temporary binder/plasticizer additives.

Another desirable component of the extrudable mixture is sodium silicate, which increases the strength of both the dry, but unfired monolith and the fired monolith, and is a flux material. The sodium silicate is thus both a binder when the monolith is in the dry state and a flux material, and is added to the extrudable mixture as a solution. The sodium silicate is desirably present in the extrudable mixture in an amount up to about 7 parts, by weight, based on the solids content of the sodium silicate, and more desirably in an amount from about 2 to about 7 parts, by weight, based on the solids content of the sodium silicate. A suitable commercially available sodium silicate solution is a 40% solids, Type N solution, available from PQ Corporation, Industrial Chemicals Division, Valley Forge, Pa. Other suitable binders for the dried monolith include but are not limited to silica sol and alumina sol.

The extrudable mixture includes water in an amount sufficient to make an extrudable mixture and desirably includes from about 60 to about 130 parts water, by weight of dry ingredients. Preferably, the water is chilled before it is added to the mixture and more preferably is added to the system at or near 0° C. This low temperature helps keep the ingredients cool during mixing, and helps to overcome any exotherm which may occur as a result of mixing the ingredients, or as a result of heating of the mixture, which occurs as a result of the mechanical action of mixing.

The extrudable mixture is formed into a shape, which will be the shape of the finished self-supporting carbon black monolith, by passing the extrudable mixture through an extrusion die. The finished self-supporting carbon black monolith usually has a block or cylindrical shape, and includes at least one passageway along its length and desirably includes a plurality of passageways extending along the length of the finished self-supporting carbon black monolith. The carbon black monolith is designed to be placed in a stream of a fluid such that the fluid is forced through the passages in the monolith. Ideally, the amount of internal surface area of the carbon black monolith exposed to the fluid is designed to maximize the efficiency of the monolith. A honeycomb-shaped structure is preferred for the finished self-supporting carbon black monolith. Honeycomb extruders are known in the art of ceramics and have been used to produce ceramic monoliths.

Desirably, the honeycomb structure of the finished self-supporting carbon black monolith has an open frontal area greater than 50 percent and up to about 85 percent, and desirably about 74 percent, after drying and firing. The open frontal area of the monolith is the percentage of open area of the monolith taken across a plane substantially perpendicular to the passageway length of the monolith. Furthermore, the finished self-supporting carbon black monolith desirably has a honeycomb pattern with square cells and about 540 cells per square inch. The honeycomb structure desirably has a cell-to-cell pitch of about 0.043 inches, a cell wall thickness of about 6 mils, and an open frontal area of about 0.0014 square inches per cell. More broadly, for a variety of applications, the cell density may vary from 1 to 900 cells per square inch or higher, with the cell wall thickness ranging from about 150 mils to about 4 mils, and the cell-to-cell pitch varying from about 1 to about 0.033 inches.

The extruded carbon black honeycomb monolith is dried in a manner so as to prevent cracking of the structure. To alleviate cracking, the extruded carbon black honeycomb monolith is dried so that water is removed at substantially the same rate throughout the carbon black honeycomb monolith. Suitable drying methods include dielectric drying, microwave drying, warm air drying with the monolith wrapped in plastic or wet cloths, vacuum drying, freeze drying, supercritical drying, and humidity control drying.

After drying, the dried extruded carbon black honeycomb monolith is fired at a temperature from about 1600 to about 1950° F. and desirably from about 1850 to about 1950° F., in a nitrogen or other non-oxidizing or slightly reducing atmosphere. The carbon black honeycomb monolith should be fired at a temperature sufficient to react the ceramic forming materials together to create a matrix for holding the carbon black and maintaining the honeycomb shape of the extrusion. The bonds created by the firing should be sufficient to create a matrix having a strength able to withstand handling and use of the carbon black monolith in intended applications. The relatively high surface area of the material forming the finished self-supporting carbon black monolith makes it desirable as a catalyst support. As will be explained more below, the finished self-supporting carbon black monolith is porous, and catalyst precursor can be applied on the exterior of the monolith and through the depth of the monolith via pores and passages in the monolith walls.

In a desired embodiment, the finished self-supporting carbon black monolith is made by extruding a mixture comprising: 30 parts, by weight, carbon black; 50 parts, by weight, ball clay; 10 parts, by weight, calcined kaolin clay; 10 parts, by weight, nepheline syenite; 2.5 parts, by weight, methylcellulose; 2.8 parts, by weight, sodium silicate solids; and sufficient extrusion aid and water to make an extrudable mixture that holds shape after extrusion. The resulting finished self-supporting carbon black monolith has a high structural integrity, exhibiting axial crushing strength of about 1500 psi and a modulus of rupture (MOR) of about 150 psi in the axial direction.

In accordance with particular embodiments, the carbon black monolith 10 can include one or more other types of particulate carbon such as activated carbon. In particular embodiments suitable activated carbons may be made from a variety of precursors including bituminous coal, lignite, peat, synthetic polymers, petroleum pitch, petroleum coke, coal tar pitch, and lignocellulosic materials. Suitable lignocellulosic materials include wood, wood dust, wood flour, sawdust, coconut shell, fruit pits, nut shell, and fruit stones. Suitable commercially available activated carbons include Nuchar® activated carbon available from MeadWestvaco Corporation of New York, N.Y., Acticarbone® carbon available from Ceca SA of Paris, France, and Darco® carbon and Norit® carbon available from Norit-Americas of Marshall, Tex.

It should be understood that the carbon black monolith catalyst of this invention could be used in a variety of applications owing to the wide range of carbon content which the carbon black monolith can contain. For example, crushing strengths of the finished self-supporting carbon black monolith will vary depending on the relative amounts of carbon black and ceramic forming material, the firing temperature, and the particle size of the ingredients. In particular embodiments, the finished self-supporting carbon black monolith may include carbon black in an amount from about 10 to about 95% by weight of the finished self-supporting carbon black monolith, preferably in an amount from about 20 to about 80% by weight of the finished self-supporting carbon black monolith, more preferably in an amount from about 30 to about 65% by weight of the finished self-supporting carbon black monolith, and even more preferably in an amount from about 30 to about 50% by weight of the finished self-supporting carbon black monolith. The higher loading of carbon (greater then 80% by weight) is more effectively achieved with a non-ceramic matrix such as carbon. Furthermore, in particular embodiments, the finished self-supporting carbon black monolith may include ceramic material or other matrix material in an amount from about 5 to about 95% by weight of the finished self-supporting carbon black monolith, preferably in an amount from about 20 to about 80% by weight of the finished self-supporting carbon black monolith, more preferably in an amount from about 35 to about 70% by weight of the finished self-supporting carbon black monolith, and even more preferably in an amount from about 50 to about 70% by weight of the finished self-supporting carbon black monolith. The axial crushing strength of the finished self-supporting carbon black monolith desirably ranges from 500 to 1600 psi.

### Carbon Black Monolith Catalyst Structure

As used herein, the term “carbon black monolith catalyst” refers to a combination of an carbon black monolith substrate and at least one catalyst precursor. The term “catalyst” means a material that is present in a reaction, adjusts the activation energy of the reaction and provides some reaction selectivity, but is not consumed in the reaction. The term “catalyst precursor” means a material that is capable of creating a catalytically active site on a substrate material. A catalyst precursor may or may not undergo a change in becoming catalytically active.

Suitable catalyst precursors are selected from precious metal, base metal, or a combination thereof. Non-limiting examples of precious metals include, but are not limited to, palladium, platinum, rhodium, ruthenium, iridium, osmium, silver, and gold. The precious metal may also be reduced precious metal, precious metal oxide, precious metal sulfide, precious metal with modifiers, or a combination thereof. Non-limiting examples of modifiers include, but are not limited to, potassium, calcium, magnesium, sodium hydrated oxides, and sodium hydroxides. Non-limiting examples of base metal include, but are not limited to, zinc, nickel, copper, manganese, iron, chromium, vanadium, molybdenum, cobalt, titanium, and combinations thereof. Base metal may also be present as oxides, hydrated oxides, carbonates, sulfides, or a combination thereof. An illustrative example of the combination of catalyst precursors may be a solution of palladium chloride and sodium carbonate, to be combined with a carbon black monolith to form a carbon black monolith catalyst.

A carbon black monolith catalyst made according to an embodiment of the present invention comprises a finished self-supporting carbon black monolith 10 such as that illustrated in FIG. 1 and described hereinabove and at least one catalyst precursor applied to the monolith. As used herein, the phrase “finished self-supporting carbon black monolith” refers to a solid-phase material comprising carbon black without any catalyst precursor yet added to the monolith.

The carbon black in the carbon black monolith catalyst is dispersed throughout the supporting matrix, giving depth to the catalyst activity and selectivity. The carbon black is bound by the supporting matrix, which desirably is an inert binder and is not susceptible to attack by reaction media.

In one embodiment of the present invention, a carbon black monolith catalyst comprises a total catalyst precursor on the finished carbon black monolith in an amount from about 0.01 percent to about 5.0 percent by weight of the carbon black monolith catalyst. The preferred range depends on the application of the metal of choice. For example, with precious metal loading, the total catalyst precursor on the finished extruded carbon black monolith may be in an amount from about 0.01 percent to about 1.0 percent by weight of carbon black monolith catalyst. In another example, with base metal loading, the total catalyst precursor on the finished extruded carbon black monolith may be in an amount from about 1.0 percent to about 5.0 percent by weight of carbon black monolith catalyst.

The carbon black monolith catalyst has one or more longitudinal passageways defined by walls having depth. The walls are porous with passageways extending into the depths of the monolith walls. Because the carbon black agglomerates in the monolith are substantially discontinuous and are dispersed throughout the ceramic matrix, it is possible, depending on the catalyst precursor and the conditions under which the catalyst precursor is applied to the monolith, for the catalyst precursor to be present on the exterior surface of the monolith walls, and into the depths of the monolith walls via passageways between the discontinuous carbon black agglomerates and via passageways between the ceramic matrix and the carbon black. Placement of the catalyst precursor within the monolith structure can be controlled by selection of catalyst precursor, and variation in parameters of catalyst precursor application such as temperature, ionic strength of catalyst precursor solution, duration of catalyst precursor application, pH of the catalyst precursor solution, and the like. The catalyst precursor therefor is desirably disposed on the surface of the finished self-supporting carbon black monolith, such surface including area on the exterior walls of the monolith as well as area within passageways and pores in the depth of the monolith walls.

As will be discussed in more detail below, embodiments of the carbon black monolith catalyst are useful in a variety of chemical processes. FIG. 2 illustrates the flow of fluid through the passages 12 in the carbon black monolith 10. A catalyst precursor applied on and within the walls of the monolith structure, becomes catalytically active, and catalyzes a chemical reaction as reactants flow through the monolith.

### Method of Making the Carbon Black Monolith Catalyst

According to an embodiment of this invention, a carbon black monolith catalyst is made by providing a finished self-supporting carbon black monolith and applying at least one catalyst precursor to the finished carbon black monolith.

The application of catalyst precursor to the finished carbon black monolith may be achieved according to any method known to those of ordinary skill in the art. In one embodiment of the present invention, the finished carbon black monolith is contacted with a solution comprising at least one catalyst precursor, such as for example, a palladium chloride solution. The solution comprising at least one catalyst precursor, hereinafter is referred to as “catalyst precursor solution”, is contacted with the finished carbon black monolith at a controlled or timed rate. “Controlled” or “timed rate” refers to the addition of the catalyst precursor solution, or other components of the coating process, at a defined rate which achieves the desired contact of the catalyst precursor to the finished carbon black monolith. “Defined rate” refers to any rate which is capable of being reproduced or recorded. For example, the “controlled” or “timed rate” may be defined as a rate of catalyst precursor solution or other coating component addition at about 0.5 cc/second/gram of finished carbon black monolith to about 50 cc/second/gram of finished carbon black monolith. In another example, the timed rate may be 0.5 cc/minute/gram of finished carbon black monolith to about 100 cc/minute/gram of finished carbon black monolith.

It is appreciated that one of ordinary skill in the art may vary the time or volume increments of the addition of the catalyst precursor solution to achieved the desired catalyst precursor application process. For example, the catalyst precursor solution may be added to the finished carbon black monolith at a timed rate of 15.0 cc every 6.0 seconds for a 6.0 gram finished carbon black monolith. The catalyst precursor solution is added for a period of time which will achieve a carbon black monolith catalyst comprising a total weight of the catalyst precursor in the amount of about 0.01% to about 5.0% by weight to the total weight of the carbon black monolith catalyst. It is appreciated that the time period will depend on the concentration of the catalyst precursor solution, and the controlled rate of addition of the catalyst precursor solution. For example, the addition of the catalyst precursor solution may last from about 10.0 minutes to about 1.0 hour.

In a sub-embodiment of the present invention, the catalyst precursor application process also comprises other components such as water, buffering agent, optional reducing agent, and optional hydrogen peroxide, optional base, and optional acid. The water preferably is deionized. As used herein “buffering agent” refers to any compound which resists changes in pH upon the addition of small amounts of either acid or base. A buffering agent comprises a weak acid or base and its salt. Non-limiting examples of a buffering agent include, but are not limited to, sodium carbonate, potassium carbonate, sodium hydroxide, potassium hydroxide, and sodium bicarbonate. As used herein, “reducing agent” refers any substance that can donate electrons to another substance or decrease the oxidation numbers in another substance. Non-limiting examples of reducing agent include, but are not limited to, sodium formate, potassium formate, hydrogen, sodium borohydride, sodium hypophosphite, hydrazine, and hydrazine hydrochloride. It is appreciate to those of ordinary skill in the art that not all metals such as base metals require a reducing agent.

In yet another sub embodiment, the chlorides of some metals, usually base metals, are soluble alone in water. Others, such as platinum or palladium, require hydrochloric acid, or being part of a potassium or sodium chloride compound for improved solubility. For example, palladium chloride may be dissolved in hydrochloric acid. In another example, sodium chloropalladite is formed by adding sodium hydroxide to palladium chloride dissolved in hydrochloric acid. Other chemical combinations to improve the solubility of the catalyst precursor are known in the art.

The temperature of the catalyst precursor solution may be from about 30.0° C. to about 75.0° C. In another example, the temperature may be from about 50.0° C. to about 65.0° C. Preferably the temperature is at 65.0° C.

The catalyst precursor solution is usually acidic. For example, the pH of the catalyst precursor solution may range from about 1.0 to about 6.9. In another example, the pH of the catalyst precursor solution may range from about 4.0 to about 6.5. The catalyst precursor application process may be carried out in an environment wherein the pH may range from about 1.0 to about 13.0 depending on the equipment and reagents utilized. It is appreciated that equipment such as stainless steel equipment (i.e. acid reactive equipment) requires a coating process environment wherein the pH is basic to avoid deterioration of the equipment. Alternatively, glass or glass-lined equipment may be suitable when using an acidic environment for the catalyst precursor application.

### Catalytic Reactions

In another embodiment of the present invention, a method for catalytic chemical reaction is provided comprising contacting at least one reactant with a carbon black monolith catalyst comprising (a) a finished self-supporting carbon black monolith having at least one passage therethrough, and comprising a supporting matrix and carbon black dispersed throughout the supporting matrix, and (b) at least one catalyst precursor on the finished carbon black monolith. The carbon black monolith catalyst is designed to be placed in a stream of a fluid containing one or more chemical reactants, such that the fluid is forced through the passages in the monolith. Ideally, the amount of internal surface area of the carbon black monolith catalyst exposed to the fluid is designed to maximize the efficiency of the catalytic reaction.

The term “reactant” as used herein refers to any chemical compound in which a catalyst can affect a chemical reaction by increasing the reaction rate, and/or lowering the activation energy, and/or create a transition state of lower energy when the chemical compound is alone, in combination with another chemical compound, or in combination with at least two chemical compounds of the same species.

The carbon monolith catalyst of the present invention is suitable for various catalytic reactions. “Catalytic reaction” or “reaction” as used herein refers to heterogeneous and homogeneous catalytic reaction.

Heterogeneous catalytic reaction involves the use of a catalyst in a different phase from the reactants. Typical examples involve a solid catalyst with the reactants as either liquids or gases, wherein one or more of the reactants is adsorbed onto the surface of the catalyst at active sites.

In one embodiment, nitrobenzene is passed through the carbon black monolith catalyst comprising palladium, and under hydrogen pressure. The result is the production of aniline.

In another embodiment, phenol is passed through the carbon black monolith catalyst comprising palladium doped with sodium, and under hydrogen pressure. The result is the production of cyclohexanone.

In yet another embodiment, crude terephthalic acid containing such color bodies as 4-carboxybenzaldehyde is passed through the carbon black monolith catalyst comprising palladium, and under hydrogen pressure. The result is the production of purified terephthalic acid with very few color bodies present.

In yet a further embodiment, hydrogen and nitrogen are passed through the carbon black monolith catalyst comprising ruthenium, and under pressure and heat. The result is the production of ammonia.

In another embodiment, carbon monoxide or carbon dioxide is passed through the carbon black monolith catalyst comprising ruthenium, and under hydrogen pressure and heat. The result is a hydrocarbon, Fisher-Tropsch Synthesis.

In yet another embodiment, hydrocarbon and water are passed through the carbon black monolith catalyst comprising ruthenium. This process is also known as steam cracking. The result is hydrogen and carbon monoxide, wherein the hydrogen may be used in a fuel cell.

In yet another embodiment, Nitrobenzene is passed through the carbon black monolith catalyst comprising platinum, and under hydrogen pressure. The result is the production of aniline.

In another embodiment, hydrogen and oxygen are passed through the carbon black monolith catalyst comprising platinum, in a fuel cell. The result is electricity.

In another embodiment, amine and aldehyde or ketone are passed through the carbon black monolith catalyst comprising sulfided platinum, and under hydrogen pressure. The result is a reductive alkylation product.

In another embodiment, nitrobenzene is passed through the carbon black monolith catalyst comprising sulfided platinum, and under hydrogen pressure. The result is a hydroxyl amine.

In another embodiment, aniline is passed through the carbon black monolith catalyst comprising rhodium, and under hydrogen pressure. The result is cyclohexylamine.

In another embodiment, phenol is passed through the carbon black monolith catalyst comprising rhodium and under hydrogen pressure. The result is cyclohexanol.

In another embodiment, gas phase catalytic reaction may also be achieved with the carbon black monolith catalyst of the present invention. Non-limiting examples include:

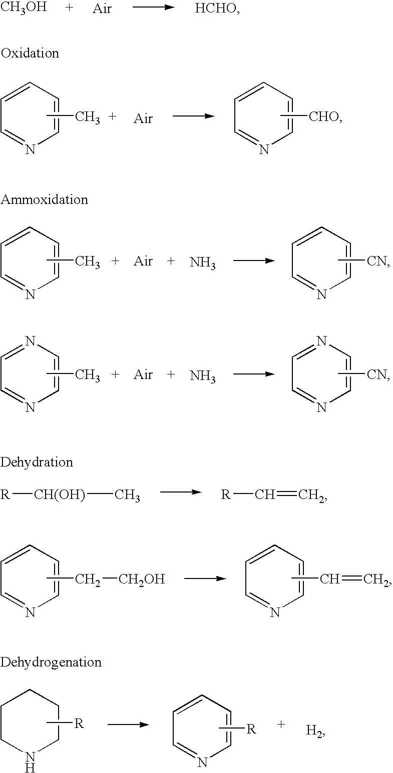

### Cyclic-Condensation and Dehydrogenation, Heterocyclic Compounds Synthesis

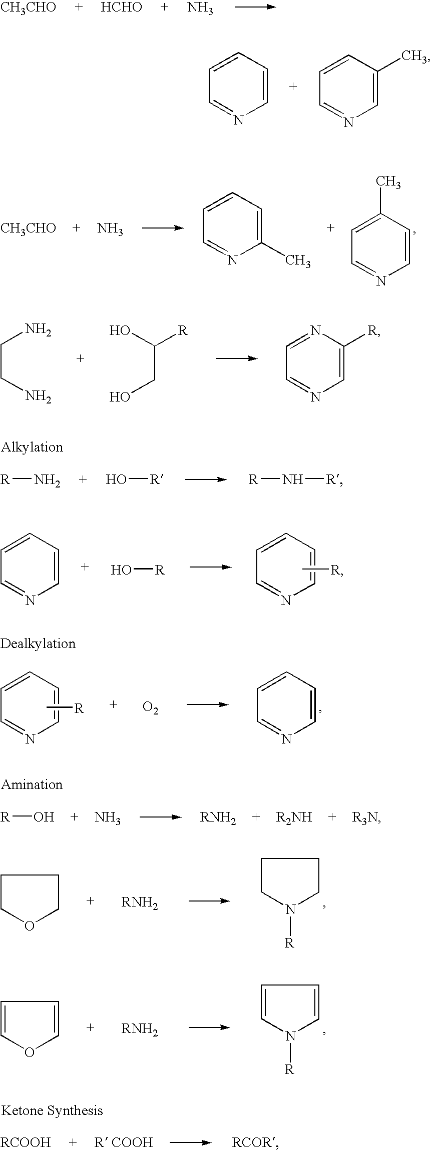

wherein R represent any chemical functional group which does not alter the chemical compounds.

Other reactions in which the carbon black monolith catalyst may participate includes, but are not limited to, chlorination, isomerization, heterobicyclic compounds synthesis, polymerization, hydrodesulfurization, and hydrodenitrogenation.

It is appreciated that one of ordinary skilled in the art, presented with the teaching of the present invention, may arrive at all the available permeations of reactants and catalytic reaction reactions.

The present invention is described above and further illustrated below by way examples which are not to be construed in any way as imposing limitations upon the scope of the invention. On the contrary, it is to be clearly understood that resort may be had to various other embodiments, modifications, and equivalents thereof which, after reading the description herein, may suggestion themselves to those skilled in the art without departing from the scope of the invention and the appended claims.

### Example 1

Four formulations (A-D) of dry ingredients as shown in Table 1 are dry blended for about 4 minutes. An appropriate amount of water to make an extrudable mixture is added, and the ingredients are wet mixed in a high energy mixer for about 5 minutes until a mixture with acceptable extrusion properties is obtained.

TABLE 1

| | Formulation in parts by weight | | | |
|---|---|---|---|---|
| Ingredient | A | B | C | D |
| Carbon black¹ | 50 | 50 | 30 | 30 |
| ball clay² | 42 | 36 | 58 | 50 |
| calcined kaolin³ | 8 | 7 | 12 | 10 |
| nepheline syenite⁴ | — | 7 | — | 10 |
| sodium silicate⁵ | — | 4.5 | — | 2.8 |
| (solids from aqueous | | | | |
| solution) | | | | |
| methyl cellulose⁶ | 4 | 4 | 2.5 | 2.5 |
| water | 83 | 102 | 66 | 75 |
| bentonite | 3 | 1 | — | — |
| surfactant⁷ | 3 | 3 | — | — |

¹Monarch 700 available from Cabot Corp.
²Available from Kentucky & Tennessee Clay Co. of Mayfield, Kentucky under the designation OLD MINE #4 Ball Clay.
³Available from Georgia Kaolin of Union, New Jersey under the designation GLOMAX LL.
⁴Available from Unimin Specialty Materials of Elco, Illinois under the trademark MINEX ®.
⁵Available from PQ Corporation, Industrial Chemicals Division of Valley Forge, Pennsylvania in solution form with 40% solids, Type N.
⁶Available from Dow Chemical Corporation of Midland, Michigan under the designation A4M.
⁷Available from Lonza of Switzerland under the designation Pegasperse.

The four mixtures are then individually extruded through honeycomb extrusion dies to form wet molded honeycomb structures, wrapped in multiple layers of plastic film to retard moisture loss, and dried in a warm air dryer at about 180 degrees F. for 24 hours.

When the monoliths are sufficiently dry, four samples are cut from each of the monoliths made from Formulations A-D. The samples are cut perpendicular to the direction of the monolith passages to a thickness of 12 mm. These samples are then fired to the temperatures shown in Table 2 for a time period of one half to one hour in an electric furnace purged with an inert atmosphere.

TABLE 2
Firing Temperature (° F.)

| Formulation | Sample 1 | Sample 2 | Sample 3 | Sample 4 |
|---|---|---|---|---|
| A | 1400 | 1600 | 1800 | 2000 |
| B | 1400 | 1600 | 1800 | 2000 |
| C | 1400 | 1600 | 1800 | 2000 |
| D | 1400 | 1600 | 1800 | 2000 |

### Example 2

Approximately 2 L of de-ionized water is added to a 3 L heated glass reactor, and agitated by a variable speed motor attached to a plastic impeller. The temperature is ambient, and recorded via a thermocouple connected to a recording device. A quantity of sodium carbonate is added to the water in the stirring reactor so as to elevate the pH to about 10.5.

A finished self-supporting carbon black monolith made in accordance with Example 1 is placed in the reactor so as to have the sodium carbonate aqueous solution pass evenly through the cells of the monolith as the solution is agitated.

In another glass container, a solution of palladium chloride is prepared so as to have a palladium metal loading by weight of the carbon monolith of 0.1%. The pH of this solution is adjusted to a pH of 4.0 using sodium bicarbonate. This solution is metered into the reactor.

After the metering of the palladium solution, the reactor is heated via an electronic temperature controlled device, so as to ramp to 65° C. in 30 minutes.

After the temperature of the reactor is stabilized at 65° C., a solution of sodium formate in water is metered into the reactor, and the reactor is allowed to stir for an additional 30 minutes.

Power to the heater is turned off and the reactor is allowed to cool to below 40° C., after which agitation is stopped, and the carbon black monolith catalyst is removed and washed free of any minerals, such as chlorides, by the use of de-ionized water.

### Example 3

In the same manner of Example 2, a finished self-supporting carbon black monolith is used to prepare a catalyst with a palladium metal loading of 5% by weight of the carbon black monolith catalyst.

Ingredients are increased proportionally to the amount of palladium metal used in this Example 3, as compared to Example 2.

While the invention has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereof.

1. A method of forming a monolith comprising the steps of:
(a). extruding an extrudable mixture through an extrusion die such that a monolith is formed having a shape wherein the monolith has at least one passage therethrough and the extrudable mixture comprises:
carbon black;
ceramic forming material;
flux material;
an extrusion aid; and
water,
the mixture being capable of maintaining the shape of the monolith after extrusion and during drying of the monolith;
(b). drying the extruded monolith; and
(c). firing the dried monolith at a temperature and for a time period sufficient to react the ceramic material together and form a ceramic matrix.

2. A method as in claim 1 wherein the extrusion aid is a surfactant.

3. A method as in claim 1 wherein the extrusion aid is a plasticizer.

4. A method as in claim 1 wherein the extrusion aid comprises a wet binder for enhancing strength and maintaining the shape of the wet extruded monolith.

5. A method as in claim 1 wherein the ceramic forming material comprises a filler for reducing shrinkage of the monolith during the steps of drying and firing.

6. A method as in claim 1 wherein the extrusion aid comprises a surfactant, a wet binder, a plasticizer, or combinations thereof for enhancing strength and maintaining the shape of the wet extruded monolith and the ceramic forming material comprises a filler for reducing shrinkage of the monolith during the steps of drying and firing.

7. A method as in claim 1 wherein the ceramic forming material comprises ball clay.

8. A method as in claim 1 wherein the flux comprises a feldspathic mineral.

9. A method as in claim 1 wherein the flux comprises nepheline syenite.

10. A method as in claim 4 wherein the binder comprises methylcellulose.

11. A method as in claim 10 wherein the binder further comprises an acrylic binder.

12. A method as in claim 1 wherein the extrudable mixture further comprises sodium silicate.

13. A method as in claim 5 wherein the ceramic forming material filler comprises calcined kaolin clay.

14. A method as in claim 1 wherein the ceramic forming material comprises ball clay and the flux comprises a feldspathic mineral.

15. A method as in claim 1 wherein:
the carbon black is present in the extrudable mixture in an amount from about 10 to about 70 parts, by weight;
the ceramic forming material is present in the extrudable mixture in an amount from about 20 to about 80 parts, by weight; and
the flux material is present in the extrudable mixture in an amount from about 2 to about 20 parts, by weight.

16. A method as in claim 1 wherein:
the carbon black is present in the extrudable mixture in an amount from about 10 to about 70 parts, by weight;
the ceramic forming material comprises ball clay present in the extrudable mixture in an amount from about 20 to about 80 parts, by weight;
the flux is a feldspathic mineral present in the extrudable mixture in an amount from about 2 to about 20 parts, by weight;
the extrudable mixture further comprises methylcellulose present in the extrudable mixture in an amount from about 0.5 to about 10 parts, by weight;
the ceramic forming material further comprises calcined kaolin clay present in the extrudable mixture in an amount from about 1 to about 15 parts, by weight; and
the water is present in the extrudable mixture in an amount from about 60 to about 130 parts, by weight.

17. A method as in claim 1 wherein:
the carbon black is present in the extrudable mixture in an amount from about 10 to about 70 parts, by weight;
the ceramic forming material comprises ball clay present in the extrudable mixture in an amount from about 20 to about 80 parts, by weight;
the flux material is nepheline syenite present in the extrudable mixture in an amount from about 2 to about 20 parts, by weight;
the extrudable mixture further comprises methylcellulose present in the extrudable mixture in an amount from about 0.5 to about 5 parts, by weight;
the extrudable mixture further comprises an acrylic binder present in the extrudable mixture in an amount from about 1 to about 30 parts solids, by weight;
the ceramic forming material further comprises calcined kaolin clay present in the extrudable mixture in an amount from about 1 to about 15 parts, by weight;
the extrudable mixture further comprises sodium silicate solids present in the extrudable mixture in an amount from about 2 to about 7 parts; and
the water is present in the extrudable mixture in an amount from about 60 to about 130 parts, by weight.

18. A method as in claim 1 wherein the drying step comprises the steps of:
placing the extruded monolith in a vacuum chamber initially having ambient room temperature and atmospheric pressure within the vacuum chamber;
reducing the pressure within the vacuum chamber at a rate and to a level sufficient to freeze the water in the monolith; and
maintaining the reduced pressure within the vacuum chamber for a time sufficient for the frozen water in the monolith to sublime until the monolith is sufficiently dry to handle without shape deformation or cracking.

19. A method as in claim 1 wherein the drying step comprises the steps of:
freezing the water in the extruded monolith;
placing the frozen extruded monolith in a vacuum chamber initially having a pressure within the vacuum chamber of atmospheric pressure;
reducing the pressure and/or temperature within the vacuum chamber at a rate and to a level sufficient to keep the water in the monolith frozen; and
maintaining the reduced pressure and/or temperature within the vacuum chamber for a time sufficient for the frozen water in the monolith to sublime until the monolith is sufficiently dry to handle without shape deformation or cracking.

20. A method as in claim 1 wherein the drying step comprises the steps of:
placing the extruded monolith in a chamber initially having a relative humidity within the chamber of at least 95%; and
gradually reducing the relative humidity within the chamber until the monolith is sufficiently dry to handle without shape deformation or cracking.

21. A method as in claim 1 wherein the carbon black is high structure carbon black.

22. A method as in claim 1 wherein the carbon black is characterized by a nitrogen B.E.T. surface area from about 25 to about 1500 m²/g.

23. A method as in claim 1 wherein the carbon black is characterized by having a particle size of 10 to 75 nm.

24. A method as in claim 1 wherein the carbon black is characterized by having a pH of 6 to 12.

25. A monolith made according to a process comprising the steps of:
(a). extruding an extrudable mixture through an extrusion die such that a monolith is formed having a shape wherein the monolith has at least one passage therethrough and the extrudable mixture comprises:
carbon black;
ceramic forming material;
flux material;
an extrusion aid; and
water,
the mixture being capable of maintaining the shape of the monolith after extrusion and during drying of the monolith;
(b). drying the extruded monolith; and
(c). firing the dried monolith at a temperature and for a time period sufficient to react the ceramic material together and form a ceramic matrix.

26. A method for drying a wet extruded monolith comprising carbon black, ceramic forming material, and water comprising the steps of:
placing the wet extruded monolith in a vacuum chamber initially having atmospheric temperature and pressure within the vacuum chamber;
reducing the pressure within the vacuum chamber at a rate and to a level sufficient to freeze the water in the monolith; and
maintaining the reduced pressure within the vacuum chamber for a time sufficient for the frozen water in the monolith to sublime until the monolith is dry.

27. A method as in claim 26 wherein, during the step of reducing pressure, the pressure within the chamber is reduced from atmospheric pressure to a pressure of less than about 1 torr.

28. A method as in claim 26 wherein, during the step of reducing pressure, the pressure within the chamber is reduced from atmospheric pressure to a pressure of less than about 1 torr within about 1 minute or less.

29. A method for drying a wet extruded monolith comprising carbon black, ceramic forming material, and water comprising the steps of:
freezing the water in the extruded monolith;
placing the frozen extruded monolith in a vacuum chamber initially having a pressure within the vacuum chamber of atmospheric pressure;
reducing the pressure and/or temperature within the vacuum chamber at a rate and to a level sufficient to keep the water in the monolith frozen; and
maintaining the reduced pressure and/or temperature within the vacuum chamber for a time sufficient for the frozen water in the monolith to sublime until the monolith is dry.

30. A method as in claim 29 wherein, during the freezing step, the water in the monolith is frozen within about 10 minutes after the extrusion step.

31. A method as in claim 29 wherein, during the freezing step, the monolith is subjected to a temperature of less than about minus 25° F.

32. A method as in claim 29 wherein, during the freezing step, the monolith is subjected to a temperature of less than about minus 80° F.

33. A method for drying a wet extruded monolith comprising carbon black, ceramic forming material, and water comprising the steps of:
placing the extruded monolith in a chamber initially having a relative humidity within the chamber of at least 95%; and
gradually reducing the relative humidity within the chamber until the monolith is dry.

34. A honeycomb-shaped monolith having at plurality of passages therethrough for receiving a flow of fluid, having an open frontal area greater than 50% and up to 85%, and comprising a fired ceramic material and carbon black dispersed throughout the ceramic material the ceramic material forming a matrix and the carbon black being supported by the matrix.

35. A monolith as in claim 34 wherein the carbon black is present in an amount from about 10 to about 95 parts by weight and the ceramic material is present in an amount from about 90 to about 5 parts, by weight.

36. A monolith as in claim 34 wherein the monolith has an axial crushing strength from about 500 to about 1600 psi.

37. A monolith as in claim 34 wherein the carbon black is high structure carbon black.

38. A monolith as in claim 34 wherein the monolith further comprises activated carbon.

39. A monolith as in claim 34 wherein the carbon black is characterized by a nitrogen B.E.T. surface area from about 25 to about 1500 m²/g.

40. A monolith as in claim 34 wherein the carbon black in characterized by a nitrogen B.E.T. surface area from about 50 to 500 m²/g.

41. A monolith as in claim 34 wherein the carbon black is characterized by a nitrogen B.E.T. surface area from about 50 to 150 m²/g.

42. A monolith as in claim 34 wherein the carbon black is characterized by having a particle size of 10 to 75 nm.

43. A monolith as in claim 34 wherein the carbon black is characterized by having a particle size of 25 to 50 nm.

44. A carbon black monolith catalyst comprising:
a finished self-supporting carbon black monolith having at least one passage therethrough and comprising a supporting matrix and carbon black dispersed throughout the supporting matrix; and
at least one catalyst precursor on said finished self-supporting carbon black monolith.

45. A carbon black monolith catalyst as in claim 44 wherein the at least one catalyst precursor is selected from the group consisting of precious metal, base metal, or a combination thereof.

46. A carbon black monolith catalyst as in claim 44 wherein the at least one catalyst precursor is selected from the group consisting of reduced precious metal, precious metal oxide, precious metal sulfide, precious metal with modifier, base metal, or a combination thereof.

47. A carbon black monolith catalyst as in claim 44 wherein the at least one catalyst precursor includes a modifier selected from the group consisting of potassium, calcium, magnesium, sodium hydrated oxides, and sodium hydroxides.

48. A carbon black monolith catalyst as in claim 44 wherein the at least one catalyst precursor is a precious metal selected from the group consisting of palladium, platinum, rhodium, ruthenium, iridium, osmium, silver, and gold.

49. A carbon black monolith catalyst as in claim 44 wherein the at least one catalyst precursor is a base metal is selected from the group consisting of zinc, nickel, copper, manganese, iron, chromium, vanadium, molybdenum, cobalt, and titanium.

50. A carbon black monolith catalyst as in claim 44 wherein the at least one catalyst precursor is a base metal catalyst selected from the group consisting of oxides, hydrated oxides, carbonates, or sulfides.

51. A carbon black monolith catalyst as in claim 44 wherein the at least one catalyst precursor is present on the finished self-supporting carbon black monolith in an amount from about 0.01% to about 5.0% by weight of the carbon black monolith catalyst.

52. A carbon black monolith catalyst as in claim 44 wherein the finished self-supporting carbon black monolith has an axial crushing strength from about 500 to about 1600 psi.

53. A carbon black monolith catalyst as in claim 44 wherein the carbon black particles are present in the finished self-supporting carbon black monolith in an amount from about 10 to about 95% by weight of the monolith and the supporting matrix is present in the finished self-supporting carbon black monolith in an amount from about 90 to about 5% by weight of the finished self-supporting carbon black monolith.

54. A carbon black monolith catalyst as in claim 44 wherein the supporting matrix is a ceramic matrix.

55. A carbon black monolith catalyst as in claim 54 wherein the carbon black is present in the finished self-supporting carbon black monolith in an amount from about 20 to about 80% by weight of the monolith and the ceramic is present in the finished self-supporting carbon black monolith in an amount from about 80 to about 20% by weight of the finished self-supporting carbon black monolith.

56. A carbon black monolith catalyst as in claim 54 wherein the carbon black is present in the finished self-supporting carbon black monolith in an amount from about 30 to about 65% by weight of the monolith and the ceramic is present in the finished self-supporting carbon black monolith in an amount from about 70 to about 35% by weight of the finished self-supporting carbon black monolith.

57. A carbon black monolith catalyst as in claim 44 wherein the carbon black is high structure carbon black.

58. A carbon black monolith catalyst as in claim 44 wherein the monolith further comprises activated carbon.

59. A carbon black monolith catalyst as in claim 44 wherein the carbon black is characterized by a nitrogen B.E.T. surface area from about 25 to about 1500 m²/g.

60. A carbon black monolith catalyst as in claim 44 wherein the carbon black is characterized by having a particle size of 10 to 75 nm.

61. A carbon black monolith catalyst as in claim 54 wherein the finished self-supporting carbon black monolith is made according to a process comprising extruding an extrudable mixture comprising the carbon black, a ceramic forming material, flux material, an extrusion aid and water, drying the extruded monolith, and firing the dried monolith at a temperature and for a time period sufficient to fuse the ceramic forming material together and form the ceramic matrix.

62. A carbon black monolith catalyst as in claim 61 wherein the flux material is a feldspathic mineral.

63. A carbon black monolith catalyst as in claim 61 wherein the feldspathic mineral is nepheline syenite.

64. A carbon black monolith catalyst as in claim 61 wherein the flux material further comprises sodium silicate.

65. A carbon black monolith catalyst as in claim 61 wherein the ceramic forming material is selected from the group consisting of ball clay, plastic kaolins, smectite clay minerals, bentonite, and combinations thereof.

66. A carbon black monolith catalyst as in claim 61 wherein the ceramic forming material further comprises a shrinkage reducing filler material.

67. A carbon black monolith catalyst as in claim 66 wherein the shrinkage reducing filler material is calcined kaolin clay.

68. A carbon black monolith catalyst as in claim 41 wherein the finished self-supporting carbon black monolith has a wall and has passageways extending into the depth of the wall, and the at least one catalyst precursor is at least partially disposed in the passageways extending into the depth of the wall.

69. A carbon black monolith catalyst as in claim 68 wherein the carbon black comprises discontinuous carbon black agglomerates and the passageways in the monolith wall include passageways between the discontinuous carbon black agglomerates and between the ceramic matrix and the carbon black of the finished self-supporting carbon black monolith.

70. A method for making a carbon black monolith catalyst comprising:
providing a finished self-supporting carbon black monolith having at least one passage therethrough and comprising a supporting matrix and carbon black dispersed throughout the supporting matrix; and
applying at least one catalyst precursor to said finished carbon black monolith.

71. A method as in claim 70 wherein the step of applying catalyst precursor comprises applying a catalyst precursor selected from the group consisting of precious metal, base metal, or a combination thereof.

72. A method as in claim 70 wherein the step of applying catalyst precursor comprises applying a catalyst precursor selected from the group consisting of reduced precious metal, precious metal oxide, precious metal sulfide, precious metal with modifier, base metal, or a combination thereof.

73. A method as in claim 70 wherein the step of applying catalyst precursor comprises applying a precious metal catalyst precursor and a modifier selected from the group consisting of potassium, calcium, magnesium, sodium hydrated oxides, and sodium hydroxides.

74. A method as in claim 70 wherein the step of applying catalyst precursor comprises applying a precious metal catalyst precursor selected from the group consisting of palladium, platinum, rhodium, ruthenium, iridium, osmium, silver, and gold.

75. A method as in claim 70 wherein the step of applying catalyst precursor comprises applying a base metal catalyst precursor selected from the group consisting of zinc, nickel, copper, manganese, iron, chromium, vanadium, molybdenum, cobalt, and titanium.

76. A method as in claim 70 wherein the step of applying catalyst precursor comprises applying a base metal catalyst precursor selected from the group consisting of oxides, hydrated oxides, carbonates, or sulfides.

77. A method as in claim 70 wherein the step of applying catalyst precursor comprises applying catalyst precursor to the finished self-supporting carbon black monolith in an amount from about 0.01% to about 5.0% by weight of the carbon black monolith catalyst.

78. A method as in claim 70 wherein the step of applying catalyst precursor includes applying the catalyst precursor in solution to the finished self-supporting carbon black monolith and drying the finished self-supporting carbon black monolith.

79. A method as in claim 70 wherein the step of applying catalyst precursor includes dipping the finished self-supporting carbon black monolith in a solution of the catalyst precursor and drying the finished self-supporting carbon black monolith.

80. A method as in claim 70 wherein the step of applying catalyst precursor includes dissolving the catalyst precursor in a liquid bath, placing the finished self-supporting carbon black monolith in the liquid bath, removing the finished self-supporting carbon black monolith from the liquid bath and drying the finished self-supporting carbon black monolith.

81. A method as in claim 70 wherein the supporting matrix is a ceramic matrix.

82. A method as in claim 81 wherein the carbon black monolith catalyst is made according to a process comprising extruding an extrudable mixture comprising the carbon black, ceramic forming material, flux material, an extrusion aid, and water, drying the extruded monolith, and firing the dried monolith at a temperature and for a time period sufficient to fuse the ceramic forming material together and form the ceramic matrix.

83. A method as in claim 82 wherein the flux material is a feldspathic mineral flux material.

84. A method as in claim 82 wherein the finished self-supporting carbon black monolith has an axial crushing strength from about 500 to about 1600 psi.

85. A method as in claim 82 wherein the carbon black is present in the finished self-supporting carbon black monolith in an amount from about 10 to about 95% by weight of the monolith and the supporting matrix is present in the finished self-supporting carbon black monolith in an amount from about 90 to about 5% by weight of the finished self-supporting carbon black monolith.

86. A method as in claim 81 wherein the carbon black is present in the finished self-supporting carbon black monolith in an amount from about 20 to about 80% by weight of the finished self-supporting carbon black monolith and the ceramic is present in the finished self-supporting carbon black monolith in an amount from about 80 to about 20% by weight of the finished self-supporting carbon black monolith.

87. A method as in claim 81 wherein the carbon black is present in the finished self-supporting carbon black monolith in an amount from about 30 to about 65% by weight of the finished self-supporting carbon black monolith and the ceramic is present in the finished self-supporting carbon black monolith in an amount from about 70 to about 35% by weight of the finished self-supporting carbon black monolith.

88. A method as in claim 70 wherein the carbon black is high structure carbon black.

89. A method as in claim 70 wherein the carbon black is characterized by a nitrogen B.E.T. surface area from about 25 to about 1500 m²/g.

90. A method as in claim 70 wherein the carbon black is characterized by having a particle size of 10 to 75 nm.

91. A method as in claim 83 wherein the feldspathic mineral is nepheline syenite.

92. A method as in claim 82 wherein the flux material further comprises sodium silicate.

93. A method as in claim 82 wherein the ceramic forming material is selected from the group consisting of ball clay, plastic kaolins, smectite clay minerals, bentonite, and combinations thereof.

94. A method as in claim 82 wherein the ceramic forming material further comprises a shrinkage reducing filler material.

95. A method for catalytic chemical reaction comprising contacting at least one reactant with a carbon black monolith catalyst comprising (a) a finished self-supporting carbon black monolith having at least one passage therethrough and comprising a supporting matrix and carbon black dispersed throughout the supporting matrix, and (b) at least one catalyst precursor on said finished self-supporting carbon black monolith.

96. A method as in claim 95, wherein the at least one catalyst precursor is selected from the group consisting of precious metal, base metal, or a combination thereof.

97. A method as in claim 95, wherein the at least one catalyst precursor is selected from the group consisting of reduced precious metal, precious metal oxide, precious metal sulfide, precious metal with modifier, base metal, or a combination thereof.

98. A method as in claim 95, wherein the at least one catalyst precursor includes a modifier selected from the group consisting of potassium, calcium, magnesium, sodium hydrated oxides, and sodium hydroxides.

99. A method as in claim 95, wherein the at least one catalyst precursor is a precious metal selected from the group consisting of palladium, platinum, rhodium, ruthenium, iridium, osmium, silver, and gold.

100. A method as in claim 95, wherein the at least one catalyst precursor is a base metal is selected from the group consisting of zinc, nickel, copper, manganese, iron, chromium, vanadium, molybdenum, cobalt, and titanium.

101. A method as in claim 95, wherein the at least one catalyst precursor is a base metal catalyst selected from the group consisting of oxides, hydrated oxides, carbonates, or sulfides.

102. A method as in claim 95, wherein the at least one catalyst precursor is present on the finished self-supporting carbon black monolith in an amount from about 0.01% to about 5.0% by weight of the carbon black monolith catalyst.

103. A method as in claim 95, wherein the finished self-supporting carbon black monolith has an axial crushing strength from about 500 to about 1600 psi.

104. A method as in claim 95 wherein the carbon black is present in the finished self-supporting carbon black monolith in an amount from about 10 to about 95% by weight of the monolith and the supporting matrix is present in the finished self-supporting carbon black monolith in an amount from about 90 to about 5% by weight of the finished self-supporting carbon black monolith.

105. A method as in claim 95 wherein the supporting matrix is a ceramic matrix.

106. A method as in claim 105, wherein the carbon black are present in the finished self-supporting carbon black monolith in an amount from about 20 to about 80% by weight of the finished self-supporting carbon black monolith and the ceramic is present in the monolith in an amount from about 80 to about 20% by weight of the finished self-supporting carbon black monolith.

107. A method as in claim 105, wherein the carbon black are present in the finished self-supporting carbon black monolith in an amount from about 30 to about 50% by weight of the finished self-supporting carbon black monolith and the ceramic is present in the monolith in an amount from about 70 to about 50% by weight of the finished self-supporting carbon black monolith.

108. A method as in claim 95, wherein the carbon black is high structure carbon black.

109. A method as in claim 95 wherein the carbon black is characterized by a nitrogen B.E.T. surface area from about 25 to about 1500 m²/g.

110. A method as in claim 95 wherein the carbon black is characterized by having a particle size of 10 to 75 nm.

111. A method as in claim 95, wherein the finished self-supporting carbon black monolith is made according to a process comprising extruding an extrudable mixture comprising the carbon black, ceramic forming material, flux material, an extrusion aid, and water, drying the extruded monolith, and firing the dried monolith at a temperature and for a time period sufficient to fuse the ceramic forming material together and form the ceramic matrix.

112. A method as in claim 111, wherein the flux material is a feldspathic mineral.

113. A method as in claim 112, wherein the feldspathic mineral is nepheline syenite.

114. A method as in claim 111, wherein the flux material further comprises sodium silicate.

115. A method as in claim 111, wherein the ceramic forming material is selected from the group consisting of ball clay, plastic kaolins, smectite clay minerals, bentonite, and combinations thereof.

116. A method as in claim 111, wherein the ceramic forming material further comprises a shrinkage reducing filler material.

117. A method as in claim 95, wherein the chemical reaction comprises an industrial chemical process.

118. A method for forming a self-supporting carbon black monolith comprising pressing a mixture comprising carbon black and a binder with a die or press so as to form at least one passage through the monolith.

119. A method as in claim 119 wherein the binder comprises a polymer resin and the method further comprises pyrolyzing the monolith to convert the binder into carbon.

120. A method for forming a self-supporting carbon black monolith comprising drawing a mixture comprising carbon black and a binder so as to form at least one passage through the monolith.
